(19) United States
(12) Patent Application Publication
(10) Pub. No.: US 2020/0025401 A1
(43) Pub. Date: Jan. 23, 2020

(54) THERMO-HYGROMETER AND METHOD OF CONTROLLING TEMPERATURE AND HUMIDITY FOR ADJUSTING INDOOR ENVIRONMENT

(71) Applicant: LG ELECTRONICS INC., Seoul (KR)

(72) Inventors: Dong Ki CHEON, Gyeonggi-do (KR); Hui Jeong SEONG, Seoul (KR); Myo Seop SIM, Gyeonggi-do (KR); Ja Hee HUR, Seoul (KR)

(21) Appl. No.: 16/588,273

(22) Filed: Sep. 30, 2019

(30) Foreign Application Priority Data
Aug. 13, 2019 (KR) 10-2019-0098744

(51) Int. Cl. F24F 11/46; F24F 11/58; F24F 11/63; G05B 13/04; G05B 13/02

(52) U.S. Cl. CPC F24F 11/46; F24F 11/58; F24F 2110/10; G05B 13/041; G05B 13/027; F24F 11/63

(57) ABSTRACT

The present disclosure relates to a thermo-hygrometer and method of controlling the thermo-hygrometer for adjusting an indoor environment to a target temperature or humidity. The thermo-hygrometer of the present disclosure may control other home appliances using an Internet-of-thing environment via a 5G communication network, and may estimate a control method for other home appliances using machine learning of artificial intelligence. The thermo-hygrometer for adjusting an indoor environment according to an embodiment of the present disclosure may include a sensor for detecting at least one among a temperature and a humidity, a communicator for communicating with an external device, a memory for storing information about at least a portion of home appliances arranged indoors, and a controller for generating a control signal for controlling at least a portion of the home appliances based on at least information about the temperature and humidity detected by the sensor.

### CROSS-REFERENCE TO RELATED APPLICATION

This application claims benefit of priority to Korean Patent Application No. 10-2019-0098744, filed on Aug. 13, 2019, the entire disclosure of which is incorporated herein by reference.

### BACKGROUND

### 1. Technical Field

The present disclosure relates to a thermo-hygrometer and method of controlling temperature and humidity for adjusting an indoor environment. More specifically, the present disclosure relates to a method of controlling a thermo-hygrometer to generate a signal for controlling home appliances so as to achieve a target temperature and humidity by detecting an indoor temperature and humidity using a list of home appliances arranged indoors.

### 2. Description of Related Art

Indoor temperature, humidity, and air quality are important environmental factors that affect the health of people staying indoors.

In particular, when vulnerable people such as infants, elderly persons, or persons having respiratory problems are present in a home, it is necessary to carefully monitor and adjust an indoor environment such as temperature, humidity, and air quality.

Meanwhile, an indoor thermo-hygrometer only detects and displays an indoor temperature and humidity and is unable to adjust the temperature and humidity. It is laborious for users to maintain an indoor environment at a target temperature and humidity by operating a necessary device while observing a temperature and humidity by themselves.

In relation to this issue, US Patent Publication No. 2016-0061472, entitled “METHOD AND DEVICE FOR CONTROLLING ROOM TEMPERATURE AND HUMIDITY”, discloses an indoor temperature and humidity adjusting method in which at least one piece of environmental information and user biometric information is obtained, control information that determines statistical information within a certain range is determined on the basis of the obtained information, and an air conditioner is controlled on the basis of the determined control information.

The above document discloses a method of adjusting an indoor temperature and humidity in consideration of the user's condition and the comfort experienced by the user by using biometric information, but does not provide specific criterion for each condition with regard to which indoor device should be controlled and how to control the device.

Korean Patent Registration No. 1939993, entitled “ENVIRONMENTAL CONTROL SYSTEM FOR CONTROLLING HOME APPLIANCES BASED ON INDOOR ENVIRONMENT”, discloses a method for providing an optimal environment while reducing an electricity cost by efficiently using power by monitoring sensor values and power consumption of home appliances in real time to control the home appliances.

The above document discloses a technique of controlling indoor home appliances by using measured sensor values, but does not provide specific criterion for each condition with regard to which indoor device should be controlled and how to control the device.

It is necessary to provide solutions to the above limitations in order to achieve a target indoor environment in an optimal manner.

Meanwhile, the above-described related art is technology information that the inventor has held for deriving the present disclosure, or has acquired in the process of deriving the present disclosure, and may not be regarded as a known technology that has been published to the general public prior to filing of the present disclosure.

### SUMMARY OF THE INVENTION

An aspect of the present disclosure is to resolve the problem of the prior art in which a method for specifically controlling indoor home appliances to achieve a target indoor environment condition cannot be provided.

Another aspect of the present disclosure is to resolve the problem of the prior art in which a relationship between home appliances having opposite effects on an indoor environment when operating indoors cannot be recognized.

Another aspect of the present disclosure is to resolve the problem of the prior art in which home appliances having opposite effects on an indoor environment when operating simultaneously cannot be restricted from operating simultaneously.

Another aspect of the present disclosure is to resolve the problem of the prior art in which different environment configurations cannot be automatically set for each indoor space.

Another aspect of the present disclosure is to resolve the problem of the prior art in which an environment control cannot be integrally performed using both an Internet-of-things server and an indoor heating control server.

A thermo-hygrometer and method of controlling temperature and humidity for adjusting an indoor environment according to an embodiment of the present disclosure may be configured to achieve a target indoor environment through an optimal scheme by recognizing influences of home appliances on an indoor environment using a list of at least a portion of home appliances arranged indoors.

A thermo-hygrometer and method of controlling temperature and humidity for adjusting an indoor environment according to another embodiment of the present disclosure may be configured to prevent conflicting home appliances from operating simultaneously by recognizing influences of home appliances on an indoor environment using a list of at least a portion of home appliances arranged indoors.

A thermo-hygrometer and method of controlling temperature and humidity for adjusting an indoor environment according to another embodiment of the present disclosure may be configured to control each home appliance in order to achieve a target environment for each space by recognizing an indoor space map and recognizing the locations of home appliances arranged in each space.

A thermo-hygrometer for adjusting an indoor environment according to an embodiment of the present disclosure may include a sensor for detecting at least one of a temperature or a humidity, a communicator for communicating with an external device, a memory for storing information about at least a portion of home appliances arranged indoors, and a controller for generating a control signal for controlling at least a portion of the home appliances to adjust an indoor environment on the basis of at least information about the at least one of temperature or humidity detected by the sensor.

The communicator of the thermo-hygrometer according to an embodiment of the present disclosure may include a receiver, which receives a signal for a set environment mode from a user terminal, wherein the environment mode may include information about a target temperature range and target humidity range, and the controller may be configured to generate the control signal for controlling at least a portion of the home appliances to adjust the indoor environment on the basis of a received environment mode, the information about the temperature and humidity detected by the sensor, and information about the home appliances.

Here, the controller may be configured to generate, when temperature and humidity detected by the sensor do not fall within the target temperature range and target humidity range set by environment mode, the control signal for controlling at least one of an air conditioner, humidifier, dehumidifier, or air purifier arranged indoors so that the indoor temperature and humidity detected by the sensor fall within the target temperature range and target humidity range.

In the thermo-hygrometer for adjusting an indoor environment according to another embodiment of the present disclosure, the controller may be configured to generate a test signal for sequentially operating at least a portion of the home appliances arranged indoors, receive, from the sensor, information about a change in the temperature or humidity due to operation of each home appliance, generate and store, in the memory, information about an influence of each home appliance on the temperature or humidity, and generate the control signal so as to prevent home appliances having opposite influences on the temperature or humidity from operating simultaneously.

Here, the controller may be configured to generate a signal for stopping operation of the air purifier if generating a signal for operating the humidifier when generating the control signal, and thereafter generate the control signal for restoring the operation of the air purifier to a state prior to the stopping if generating a signal for stopping operation of the humidifier.

Furthermore, the controller may be configured to generate, when the temperature detected by the sensor is higher than the target temperature range set by the environment mode, and the humidity detected by the sensor is lower than the target humidity range set by the environment mode, a control signal for: operating an air conditioner arranged indoors until the temperature set by the sensor falls within the set target temperature range; stopping operation of an air purifier arranged indoors, and operating a humidifier arranged indoors until the humidity detected by the sensor falls within the set target humidity range; and restoring the operation of the air purifier to a state prior to the stopping after stopping operation of the humidifier.

Furthermore, the communicator may further include a transmitter for transmitting the control signal to at least one of a heating adjustment server for controlling an indoor heating system or an Internet-of-things server for controlling the home appliances arranged indoors.

Here, the controller may be configured to generate a signal for controlling the indoor heating system as a signal for the heating adjustment server, and generate a signal for controlling the home appliances as a signal for the Internet-of-things server.

The communicator of the thermo-hygrometer according to another embodiment of the present disclosure may be configured to receive map information about an indoor space and location information about the home appliances arranged indoors from a robot cleaner which cleans while moving indoors, receive temperature or humidity information from home appliances which detect a temperature or humidity among the home appliances arranged indoors, and receive, from the user terminal, a first environment mode for a first space of the indoor space and a second environment mode for a second space of the indoor space.

Here, the controller may be configured to generate the control signal for controlling at least a portion of the home appliances arranged indoors so that a temperature and humidity of the first space fall within a first target temperature range and first target humidity range set by the first environment mode and a temperature and humidity of the second space fall within a second target temperature range and second target humidity range set by the second environment mode, on the basis of the map information, the locations of the home appliances, the temperature or humidity information received from the home appliances which detect the temperature or humidity, and the information about the temperature or humidity detected by the sensor.

Furthermore, the controller may be configured to generate map data for displaying temperature and humidity information for each space on a map of an indoor space, on the basis of the map information, the locations of home appliances, the temperature or humidity information received from the home appliances which detect temperature or humidity, and the temperature or humidity information detected by the sensor.

Here, the communicator may be configured to transmit the map data to an augmented reality device of a user.

A method of controlling a thermo-hygrometer for adjusting an indoor environment according to an embodiment of the present disclosure may include receiving a list of at least a portion of home appliances arranged indoors, detecting an indoor current temperature and humidity through a sensor, and generating a control signal for controlling at least a portion of the home appliances to adjust an indoor environment on the basis of information about the detected temperature and humidity.

Here, the method may further include before the generating the control signal, receiving an environment mode set for the indoor environment, wherein the generating the control signal may include generating a control signal for controlling at least a portion of the home appliances on the basis of the set environment mode, the current temperature and humidity, and the list of the home appliances so that a detected temperature and humidity fall within a target temperature range and target humidity range set by the environment mode.

Furthermore, the generating the control signal may include generating, when the detected current temperature and humidity do not fall within the target temperature range and target humidity range set by the environment mode, a control signal for controlling at least one of an air conditioner, humidifier, dehumidifier, or air purifier arranged indoors so that the detected temperature and humidity fall within the target temperature range and target humidity range.

The method of controlling the thermo-hygrometer according to another embodiment of the present disclosure may include before the generating the control signal, generating a test signal for sequentially operating at least a portion of the home appliances arranged indoors, and receiving, from the sensor, information about a change in a temperature or humidity due to operation of each home appliance, and generating and storing, in a memory of the thermo-hygrometer, a deep neural network model for estimating operations of home appliances required for changing the temperature or humidity on the basis of the information about the change in the temperature or humidity, wherein the generating the control signal may include generating a control signal for each home appliance using the deep neural network model.

Here, the generating the control signal may include determining whether a signal for operating the humidifier is generated, and when the signal for operating the humidifier is generated, storing a current operation of the air purifier and generating a signal for stopping operation of the air purifier.

The generating the control signal may include determining whether a signal for stopping operation of the humidifier is generated and generating a signal for resuming the stored current operation of the air purifier when the signal for stopping the operation of the humidifier is generated.

Furthermore, when the temperature detected by the sensor is higher than the target temperature range set by the environment mode, and the humidity detected by the sensor is lower than the target humidity range set by the environment mode, the generating the control signal may include generating a control signal for: operating the air conditioner arranged indoors until the temperature set by the sensor falls within the set target temperature range; stopping operation of the air purifier arranged indoors, and operating the humidifier arranged indoors until the humidity detected by the sensor falls within the set target humidity range; and restoring the operation of the air purifier to a state prior to the stopping after stopping operation of the humidifier.

The method of controlling the thermo-hygrometer according to another embodiment of the present disclosure may further include before the generating the control signal, receiving map information about an indoor space and location information about the home appliances arranged indoors from a robot cleaner which cleans while moving indoors, receiving temperature or humidity information from home appliances which detect a temperature or humidity among the home appliances arranged indoors, and receiving, from a user terminal, a first environment mode for a first space of the indoor space and a second environment mode for a second space of the indoor space.

Furthermore, the generating the control signal may include generating a control signal for controlling at least a portion of the home appliances arranged indoors so that a temperature and humidity of the first space fall within a first target temperature range and first target humidity range set by the first environment mode and a temperature and humidity of the second space fall within a second target temperature range and second target humidity range set by the second environment mode, on the basis of the map information, the locations of the home appliances, the temperature or humidity information received from the home appliances which detect the temperature or humidity, and the information about the temperature or humidity detected by the sensor.

The method may further include after the generating the control signal, generating map data which displays temperature and humidity information for each space on a map of the indoor space on the basis of the map information, the locations of the home appliances, the temperature or humidity information received from the home appliances which detect the temperature or humidity, and the information about the temperature or humidity detected by the sensor, and transmitting the map data to an augmented reality device of a user.

A computer-readable medium for controlling a thermo-hygrometer according to an embodiment of the present disclosure may be one in which a computer program for executing one of the above methods is stored.

Other aspects, features, and advantages of the present disclosure will become apparent from the detailed description and the claims in conjunction with the accompanying drawings.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating an environment in which a thermo-hygrometer according to an embodiment of the present disclosure operates;

FIG. 2 is a block diagram illustrating a system in which a thermo-hygrometer according to an embodiment of the present disclosure operates;

FIG. 3 is a flowchart illustrating a method of controlling a thermo-hygrometer according to an embodiment of the present disclosure;

FIG. 4 is a diagram illustrating a control screen of a thermo-hygrometer according to an embodiment of the present disclosure;

FIG. 5 is a diagram for describing an environment mode set to operate a thermo-hygrometer according to an embodiment of the present disclosure;

FIG. 6 is a diagram for describing a method for a thermo-hygrometer according to an embodiment of the present disclosure to control a home appliance and air conditioning/heating system according to an environment condition;

FIG. 7 is a diagram for describing a home appliance and air conditioning/heating system controlled according to a temperature and humidity detected by a thermo-hygrometer according to an embodiment of the present disclosure;

FIG. 8 is a diagram for describing a method for a thermo-hygrometer according to an embodiment of the present disclosure to control a home appliance when temperature and humidity are higher than target ranges;

FIG. 9 is a diagram for describing a method for a thermo-hygrometer according to an embodiment of the present disclosure to control a home appliance when temperature is higher than a target range and humidity is lower than a target range;

FIG. 10 is a diagram for describing a method for a thermo-hygrometer according to an embodiment of the present disclosure to control a home appliance and heating system when temperature is lower than a target range and humidity is higher than a target range;

FIG. 11 is a diagram for describing another method for a thermo-hygrometer according to an embodiment of the present disclosure to control a home appliance and heating system when temperature is lower than a target range and humidity is higher than a target range;

FIG. 12 is a diagram for describing another method for a thermo-hygrometer according to an embodiment of the present disclosure to control a home appliance and heating system when temperature and humidity are lower than target ranges; and

FIG. 13 is a diagram illustrating a deep neural network model for generating another scheme for a thermo-hygrometer according to an embodiment of the present disclosure to control a home appliance and air conditioning/heating system.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms, and should be construed as including all modifications, equivalents, or alternatives that fall within the sprit and scope of the present disclosure. The aspects are provided to make the description of the present disclosure thorough and to fully convey the scope of the present disclosure to those skilled in the art. In relation to describing the present disclosure, when the detailed description of the relevant known technology is determined to unnecessarily obscure the gist of the present disclosure, the detailed description may be omitted.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. Although the terms first, second, etc. may be used herein to describe various elements, these elements should not be limited by these terms. These terms may be only used to distinguish one element from other elements.

Hereinafter, embodiments of the present disclosure will be described in detail with reference to the accompanying drawings. Like reference numerals designate like elements throughout the specification, and overlapping descriptions of the elements will not be provided.

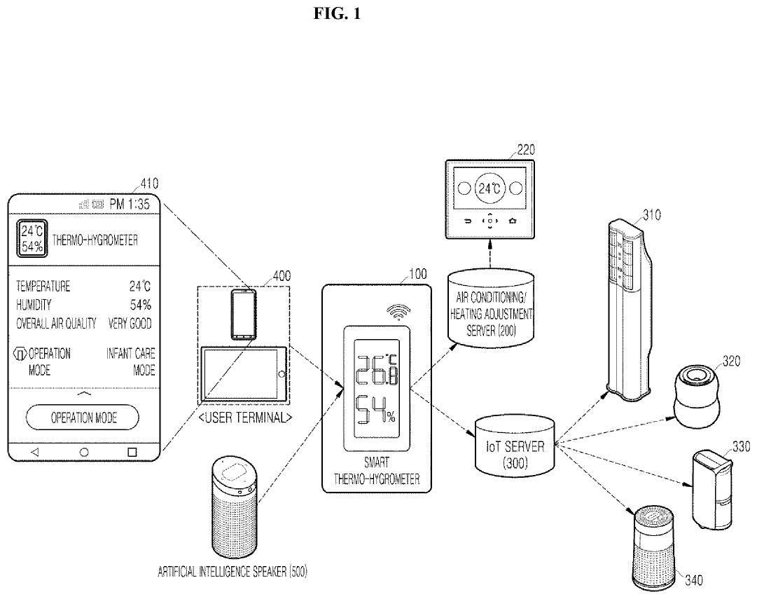

FIG. 1 is a diagram illustrating an environment in which a thermo-hygrometer according to an embodiment of the present disclosure operates.

A thermo-hygrometer 100 according to an embodiment of the present disclosure may communicate with a user terminal 400 and an artificial intelligence speaker 500 to receive information about an environment mode desired by a user. Furthermore, the thermo-hygrometer 100 may transfer information about a current temperature and humidity detected by the thermo-hygrometer 100 to the user terminal 400 or the artificial intelligence speaker 500 to notify the current temperature and humidity to a user via audio or visual information. Meanwhile, although the user terminal 400 is described as being distinguished from the artificial intelligence speaker 500 herein, it would be obvious that the artificial intelligence speaker may also be referred to as a certain user terminal in that the artificial intelligence speaker receives a command from the user and provides a response to the user.

A current temperature 24° C. and a current humidity 54% of an indoor space may be displayed on a temperature/humidity control application screen 410 of the user terminal 400. In addition, air quality of the indoor space may also be displayed.

Furthermore, information about a mode for achieving a target environment may be displayed on the temperature/humidity control application screen 410. The user may select a desired mode by touching an operation mode.

The type of the operation mode (also referred to as an environment mode) may include a season mode, an infant care mode, a change-of-seasons mode, a maternity mode, a mode for the elderly and infirm and patients, and the like, and these modes are described in detail below.

The thermo-hygrometer 100 may receive information about a mode desired by the user from the user terminal 400 or the artificial intelligence speaker 500, and may generate a control signal for controlling a home appliance and heating system so as to achieve a target temperature range and a target humidity range according to a received environment mode.

Thereafter, the thermo-hygrometer 100 may transmit an air conditioning/heating adjustment server control signal for controlling an air conditioning/heating system to an air conditioning/heating adjustment server 200, and may transmit an Internet-of-things (IoT) server control signal for controlling home appliances to an Internet-of-things server 300.

The air conditioning/heating adjustment server 200 may adjust a heating system 220, a system air conditioner, and the like arranged fixedly to adjust indoor air conditioning/heating in a home or office using the received air conditioning/heating adjustment server control signal.

The Internet-of-things server 300 may adjust home appliances such as an air conditioner 310, a humidifier 320, a dehumidifier 330, and an air purifier 340 arranged indoors in a home or office using the received Internet-of-things server control signal.

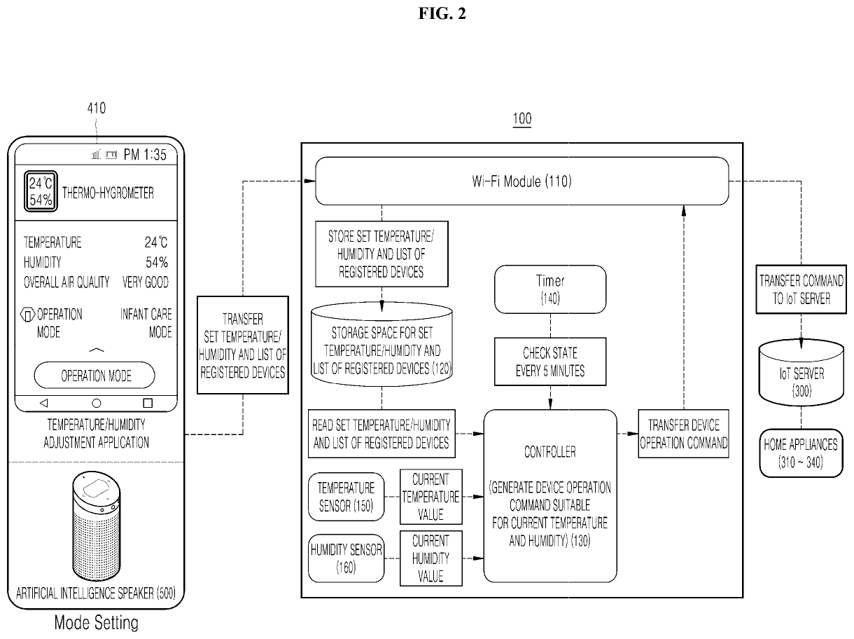

FIG. 2 is a block diagram illustrating a system in which a thermo-hygrometer according to an embodiment of the present disclosure operates.

The user terminal 400 or the artificial intelligence speaker 500 may communicate with the air conditioning/heating adjustment server 200 and the Internet-of-things server 300 to receive information about an air conditioning/heating system and home appliances used in a home or office.

Furthermore, the user terminal 400 or the artificial intelligence speaker 500 may identify environmental home appliances that may affect temperature, humidity, or air quality among the above home appliances.

In addition, the user may select a desired operation mode from the temperature/humidity control application screen 410 of the user terminal 400, and may command the desired operation mode to the artificial intelligence speaker 500 by voice.

Accordingly, the user terminal 400 or the artificial intelligence speaker 500 may transfer, to the thermo-hygrometer 100, a set environment mode or information about a target temperature range and target humidity range according to the environment mode, and a list of registered indoor devices.

Here, the list of devices may be a list of all of the home appliances arranged indoors, or may be a list of only home appliances that affect temperature or humidity.

A Wi-Fi module 110 of the thermo-hygrometer 100, which is a communicator for communicating with an external device, may receive, from the user terminal 400 or the artificial intelligence speaker 500, the set environment mode or information about a target temperature range and target humidity range according to the environment mode, and the list of registered indoor devices.

The thermo-hygrometer 100 may store the received set temperature and humidity range and list of registered devices in a storage space 120. The storage space 120 may be a memory embedded in the thermo-hygrometer 100.

A controller 130 of the thermo-hygrometer 100 may receive information about a temperature and humidity of an indoor space in which the thermo-hygrometer 100 is installed from a sensor including a temperature sensor 150 and a humidity sensor 160. Although not illustrated in FIG. 2, the sensor may include a dust sensor for detecting fine dust or ultra-fine particles.

The controller 130 may generate a control signal for controlling at least a portion of home appliances to adjust an indoor environment on the basis of at least temperature and humidity information detected through the sensor.

A timer 140 of the thermo-hygrometer 100 may be configured to operate the controller 130 to check temperature and humidity information received from the temperature sensor 150 and the humidity sensor 160, for example, every five minutes.

The control signal generated by the controller 130 may include a command for operating a device (a home appliance or the like), and may be transferred to the Internet-of-things server 300 via the Wi-Fi module 110.

Meanwhile, the communicator of the thermo-hygrometer 100 may be one including a receiver for receiving, from the user terminal 400, a signal for an environment mode set by the user and a transmitter for transmitting a control signal to at least one of the air conditioning/heating adjustment server 200 for controlling an indoor air conditioning/heating system or the Internet-of-things server 300 for controlling home appliances arranged indoors.

The control signal may include a command for controlling a heating system or system air conditioner fixedly installed indoors, and may also be transmitted to the air conditioning/heating adjustment server 200.

The Internet-of-things server 300 may control operation of home appliances connected to the Internet-of-things 300 according to a received control signal.

Meanwhile, the controller 130 of the thermo-hygrometer 100 according to an embodiment of the present disclosure may perform an operation of testing each home appliance to determine which influence is given from indoor home appliances to temperature and humidity.

The controller 130 may generate a test signal for sequentially operating at least a portion of indoor home appliances or air conditioning/heating systems, may detect, through the sensor, how temperature, humidity, or air quality changes while each home appliance or air conditioning/heating system is operated, and may generate and store, in a memory, information about an influence of each home appliance or air conditioning/heating system on temperature, humidity, or air quality on the basis of change information about temperature, humidity, or air quality received from the sensor.

For example, the controller 130 may generate and store information indicating a decrease in temperature for the air conditioner 310, information indicating an increase in temperature and a decrease in humidity for the heating system 220, information indicating a decrease in humidity for the dehumidifier 330, information indicating an increase in humidity and a decrease in air quality (increase the concentration of fine dust detected by a dust sensor) for the humidifier 320, and information indicating improvement of air quality and a decrease in humidity for the air purifier 340.

After the influence on temperature, humidity, or air quality is stored for each home appliance or air conditioning/heating system as described above, the controller 130 may generate a control signal so that home appliances or air conditioning/heating system which give conflicting influences may not operate simultaneously.

For example, when the humidifier 320 is operated to increase humidity, the controller 130 may stop operation of the air purifier which decreases humidity. This is because the air purifier 340 may degrade effects of operation of the humidifier 320 by absorbing moisture-containing molecules generated by the humidifier 320, and may unnecessarily excessively operate by detecting the moisture-containing molecules sprayed by the humidifier 320 as fine dust.

Therefore, when generating a signal for operating the humidifier 320 to increase humidity, the controller 130 may generate a signal for stopping operation of the air purifier 340, and, thereafter, when generating a signal for stopping operation of the humidifier 320, the controller 130 may generate a control signal for restoring operation of the air purifier 340 to a state prior to stopping the operation of the air purifier 340.

For example, when generating a control signal for operating the humidifier 320 to increase humidity while the air purifier 340 operates, the controller 130 may generate a control signal that stops the air purifier 340 first, and after the humidity is sufficiently increased, when generating a control signal for stopping operation of the humidifier 320, the controller 130 may generate a control signal that resumes operation of the air purifier 340.

Meanwhile, if the air purifier 340 was already in an off state when generating a control signal for operating the humidifier 320, the air purifier 340 may remain in the off state when generating a control signal for stopping operation of the humidifier 320 after the humidifier 320 is operated.

Due to this operation of the controller 130, an indoor environment may be adjusted more efficiently and effectively.

Furthermore, although not illustrated in FIG. 2, a robot cleaner may be arranged, which cleans while moving in a home or office. The robot cleaner may generate map information about an indoor space by using a camera and/or detecting a collision while moving indoors, and may also generate location information about indoor home appliances by using the camera.

A communicator 110 of the thermo-hygrometer 100 may receive, from the robot cleaner, the map information about an indoor space and the location information about indoor home appliances, and may receive information about a temperature or humidity at a location in which each of home appliances that detect a temperature or humidity, among the indoor home appliances, is located.

Furthermore, the user may set different environment modes for partitioned spaces in a home or office using the user terminal 400. For example, the user may set an infant care mode for an infant room in which an infant lives and may set a season mode for a main room in which parents live.

That is, the user may set a first environment mode for a first indoor space, and may set a second environment mode different from the first environment mode for a second indoor space.

In this case, the communicator 110 may receive, from the user terminal 400, the first environment mode for the first indoor space and the second environment mode for the second indoor space.

The controller 130 may recognize temperature or humidity information about each of partitioned indoor spaces on the basis of the map information about an indoor space received via the communicator 110, the location of home appliances on the map, information about a temperature or humidity at a location in which each of home appliances that detect a temperature or humidity, among the indoor home appliances, is located, and temperature or humidity information detected by the sensor of the thermo-hygrometer 100.

Accordingly, a control signal may be generated for controlling at least a portion of the indoor home appliances so that the temperature and humidity of the first indoor space fall within a first target temperature range and a first target humidity range set by the first environment mode, and the temperature and humidity of the second indoor space fall within a second target temperature range and a second target humidity range set by the second environment mode.

Furthermore, the controller may be configured to further generate map data for displaying temperature and humidity information for each space on a map of an indoor space, on the basis of the map information, the locations of home appliances, the temperature or humidity information received from home appliances that detect temperature or humidity, and the temperature or humidity information detected by the sensor.

Furthermore, the communicator may transmit this map data to an augmented reality device of the user, and the augmented reality device may display temperature and humidity information on an image in a space viewed by the user through the augmented reality device.

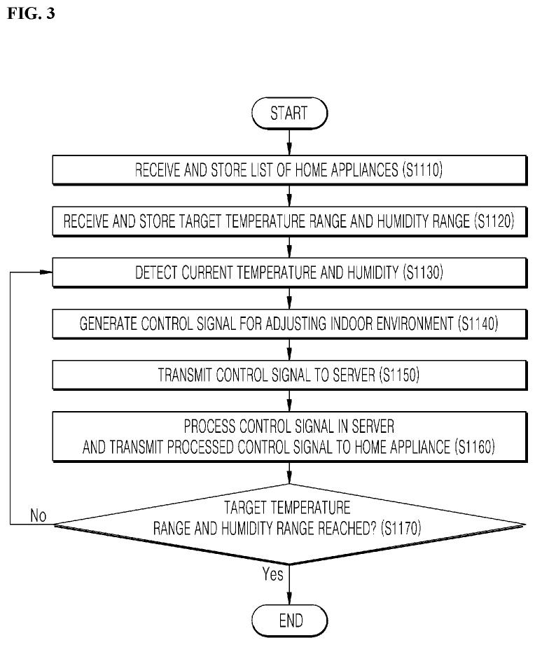

FIG. 3 is a flowchart illustrating a method of controlling a thermo-hygrometer according to an embodiment of the present disclosure.

The thermo-hygrometer 100 may receive and store, in a memory, a list of home appliances arranged indoors from the user terminal 400 or the artificial intelligence speaker 500 (S1110).

Furthermore, the thermo-hygrometer 100 may receive and store, in the memory, an environment mode desired by the user or information about a target temperature range and humidity range (S1120).

The thermo-hygrometer 100 may detect a current temperature and humidity in real time (S1130), and may generate a control signal for adjusting an indoor environment when the current temperature and humidity are outside the target temperature range and humidity range (S1140).

The control signal may be transmitted to the Internet-of-things server 300 and/or the air conditioning/heating adjustment server 200 via the communicator of the thermo-hygrometer 100 (S1150), and each of the servers may process the control signal to transmit the processed control signal to a home appliance or air conditioning/heating system connected to each of the servers (S1160).

The thermo-hygrometer 100 periodically detects an indoor temperature and humidity to determine whether the detected temperature and humidity reach a target temperature range and humidity range desired by the user, and ends a process if the target temperature range and humidity range are reached, and repeats the process of generating and transmitting a control signal for adjusting an indoor environment according to a current temperature and humidity if the target temperature range and humidity range are not reached.

Even if the target temperature range and humidity range are reached once, the thermo-hygrometer 100 may continuously detect an indoor temperature and humidity, and may restart the process of generating and transmitting a control signal for detecting a current temperature and humidity and adjusting an indoor environment when the detected current temperature and humidity are outside the target temperature range and humidity range.

Although not illustrated in detail in FIG. 3, the thermo-hygrometer 100 according to an embodiment of the present disclosure may generate a test signal for sequentially operating at least a portion of indoor home appliances, before generating a control signal.

Furthermore, information about a temperature, humidity, or air quality that changes due to operation of each home appliance may be received from the sensor, and a deep neural network model may be learned, which predicts, on the basis of the received change information about the temperature, humidity, or air quality, a change in the temperature, humidity, or air quality when operating home appliances.

For example, data may be observed through the sensor, the data indicating that the temperature decreases by 3° C. from 27° C. to 24° C. when an air conditioner is operated for three minutes with the strength of “high”, the humidity increases by 2% from 45% to 47% and the concentration of fine dust increases from 25 μg/m³ to 30 μg/m³ when a humidifier is operated for three minutes with the strength of “medium”, the temperature increases by 2° C. from 20° C. to 22° C. and the humidity decreases from 47% to 45% when a heating system is operated for three minutes with the strength of “high”, and the concentration of fine dust decreases from 30 μg/m³ to 28 μg/m³ and the humidity decreases from 47% to 45% when an air purifier is operated for three minutes with the strength of “high”.

The deep neural network model may be learned using a training data set including the data related to an operation mode and operation time of each home appliance and obtained through the above observation and a change in a temperature, humidity, or air quality as a label, and accordingly, the deep neural network model for predicting a change in the temperature, humidity, or air quality when operating home appliances may be generated.

This deep neural network model may be stored in the memory 120 of the thermo-hygrometer 100, and thereafter, in order to achieve a target temperature, humidity, and air quality, the controller 130 may generate a control signal for each home appliance using the deep neural network model trained to predict a change in a temperature, humidity, or air quality when operating home appliances.

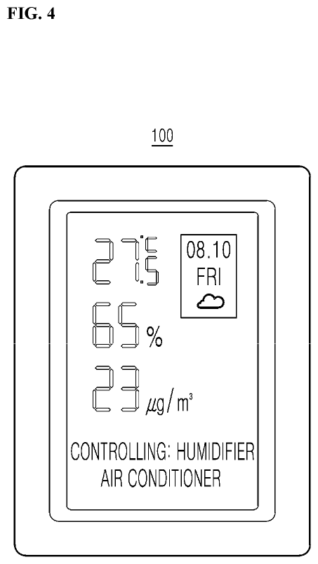

FIG. 4 is a diagram illustrating a control screen of a thermo-hygrometer according to an embodiment of the present disclosure.

A display of the thermo-hygrometer 100 may display values of a current temperature, humidity, and fine dust concentration. Furthermore, as illustrated in FIG. 4, today's date, day of the week, and weather may also be displayed on the display of the thermo-hygrometer 100.

The temperature and humidity may be detected in real time so as to be displayed on the thermo-hygrometer 100, or may be detected by the sensor at a certain period (e.g., five minutes) according to operation of the timer 140 so as to be displayed.

Furthermore, the thermo-hygrometer 100 according to an embodiment of the present disclosure may display information about a home appliance or air conditioning/heating system that is currently being operated to achieve a target temperature, humidity, or air quality.

It may be recognized from FIG. 4 that a humidifier and an air conditioner are operating to decrease a temperature and humidity since the temperature of 27.5° C. is higher than a target temperature and the humidity of 65% is higher than a target humidity.

Although not illustrated in FIG. 4, the thermo-hygrometer 100 according to an embodiment of the present disclosure may additionally display a target temperature, humidity, or air quality so that the user may recognize a current target for which air conditioning/heating systems and home appliances are being controlled.

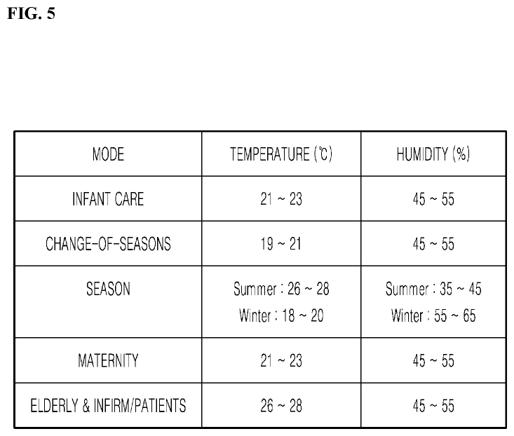

FIG. 5 is a diagram for describing an environment mode set to operate a thermo-hygrometer according to an embodiment of the present disclosure.

FIG. 5 exemplarily illustrates an infant care mode, a change-of-seasons mode, a season mode, a maternity mode, and a mode for the elderly and infirm and patients, but a settable mode is not limited thereto, and a mode may be added or removed according to an embodiment.

Each environment mode has a target temperature range and humidity range. The infant care mode has a target temperature range of 21-23° C. and a target humidity range of 45-55%.

The change-of-seasons mode has a target temperature range of 19-21° C. and a target humidity range of 45-55%. In the case of the season mode, the target temperature range is 26-28° C. and the target humidity range is 35-45% for summer, and the target temperature range is 18-20° C. and the target humidity range is 55-65% for winter. The maternity mode has a target temperature range of 21-23° C. and a target humidity range of 45-55%, and the mode for the elderly and infirm and patients has a target temperature range of 26-28° C. and a target humidity range of 45-55%.

The target temperature range and humidity range may be set for each mode as described above, but may also be adjusted by the user.

When the user selects one from among the above modes, the thermo-hygrometer 100 according to an embodiment of the present disclosure generates a control signal for controlling at least a portion of air conditioning/heating systems and home appliances to change an indoor temperature and humidity so that the indoor temperature and humidity fall within a target temperature range and humidity range according to the selected mode.

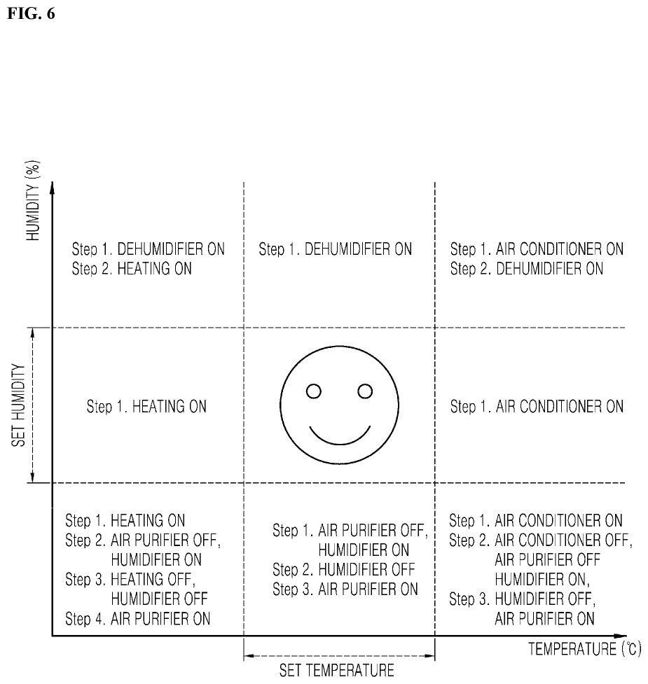

FIG. 6 is a diagram for describing a method for the thermo-hygrometer 100 according to an embodiment of the present disclosure to control a home appliance and air conditioning/heating system according to an environment condition.

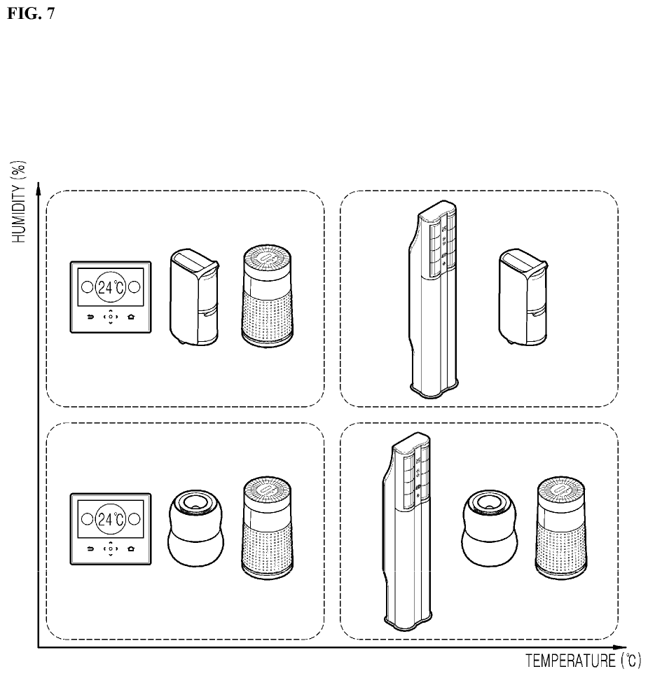

FIG. 7 is a diagram for describing a home appliance and air conditioning/heating system controlled according to a temperature and humidity detected by a thermo-hygrometer according to an embodiment of the present disclosure.

Referring to FIG. 6, when a detected current temperature and humidity fall within a set target temperature range and a set target humidity range in the graph in which the x-axis indicates the temperature and the y-axis indicates the humidity, the thermo-hygrometer 100 does not generate a control signal for controlling at least a portion of air conditioning/heating systems and home appliances.

Referring to FIGS. 6 and 7, when a current temperature and humidity are higher than a target temperature and humidity, the thermo-hygrometer 100 may generate a control signal for turning on the air conditioner 310 first and turning on the dehumidifier 330. When the air conditioner 310 and the dehumidifier 330 operate according to this control signal, an indoor temperature and humidity may decrease and fall within target ranges.

When the current temperature is higher than the target temperature but the current humidity is lower than the target humidity, the thermo-hygrometer 100 may generate a control signal for turning on the air conditioner 310 first, turning off the air conditioner 310 after the temperature has sufficiently decreased, turning off the air purifier 340 and turning on the humidifier 320, turning off the humidifier 320 after the humidity has sufficiently increased, and turning on the air purifier 340 again.

Here, the air purifier 340 is turned off when turning on the humidifier 320 since the air purifier 340 may detect moisture-containing molecules discharged from the humidifier 320 as fine dust to perform an unnecessarily excessive purifying operation, and may degrade the humidifying effect of the humidifier 320 by absorbing the moisture-containing molecules.

It may be recognized from FIG. 6 that the humidifier 320 and the air purifier 340 are restricted from operating simultaneously when a detected humidity is lower than a target humidity range.

When the current temperature and humidity are lower than the target temperature and humidity, the thermo-hygrometer 100 may generate a control signal for turning on the heating system 220 first, turning off the air purifier 340 and turning on the humidifier 320 after the temperature has sufficiently increased, turning off the heating system 200 and the humidifier 320 after the humidity has sufficiently increased, and turning on the air purifier 340 again.

When the current temperature is lower than the target temperature but the current humidity is higher than the target humidity, the thermo-hygrometer 100 may generate a control signal for turning on the dehumidifier 330 first, turning on the heating system 200, and turning off the dehumidifier 330 and the heating system 200 after the humidity has sufficiently decreased and the temperature has sufficiently increased.

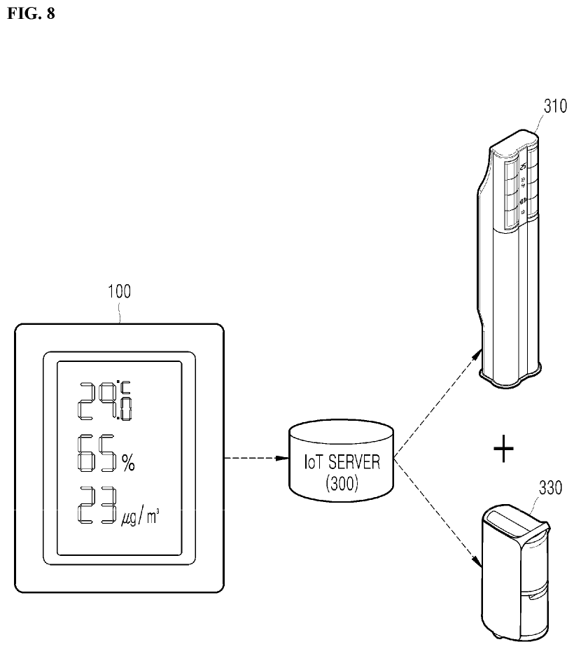

FIG. 8 is a diagram for describing a method for a thermo-hygrometer according to an embodiment of the present disclosure to control a home appliance when temperature and humidity are higher than target ranges.

If the temperature and humidity detected by the sensor are 29° C. and 65% when a set environment mode is the season mode and the season is summer, the thermo-hygrometer 100 may generate and transmit, to the Internet-of-things server 300, a control signal for turning on the air conditioner 310 and turning on the dehumidifier 330 since the temperature is higher than the target temperature range of 26-28° C. according to the set environment mode and the humidity is also higher than the target humidity range of 35-45%.

The Internet-of-things server 300 may operate the air conditioner 310 and the dehumidifier 330 according to the received control signal so that the temperature and humidity reach the target temperature range and humidity range.

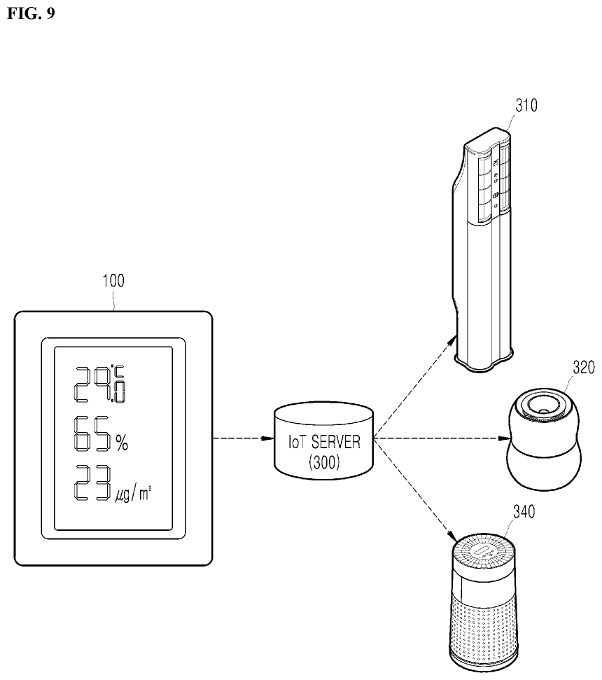

FIG. 9 is a diagram for describing a method for a thermo-hygrometer according to an embodiment of the present disclosure to control a home appliance when temperature is higher than a target range and humidity is lower than a target range.

If the temperature and humidity detected by the sensor are 29° C. and 35% when the set environment mode is the infant care mode, the thermo-hygrometer 100 may generate and transmit, to the Internet-of-things server 300, a control signal for turning on the air conditioner 310, and turning off the air conditioner 310, turning off the air purifier 340, and turning on the humidifier 320 after the temperature has sufficiently decreased, and turning off the humidifier 320 and turning on the air purifier 340 again after the humidity has sufficiently increased since the temperature is higher than the target temperature range of 21-23° C. according to the set environment mode and the humidity is lower than the target humidity range of 45-55%.

The Internet-of-things server 300 may operate the air conditioner 310 and the humidifier 320 according to the received control signal so that the temperature and humidity reach the target temperature range and humidity range.

In addition, the control signal may include a command for controlling so that the air purifier 340 is not operated when the humidifier 330 is operated.

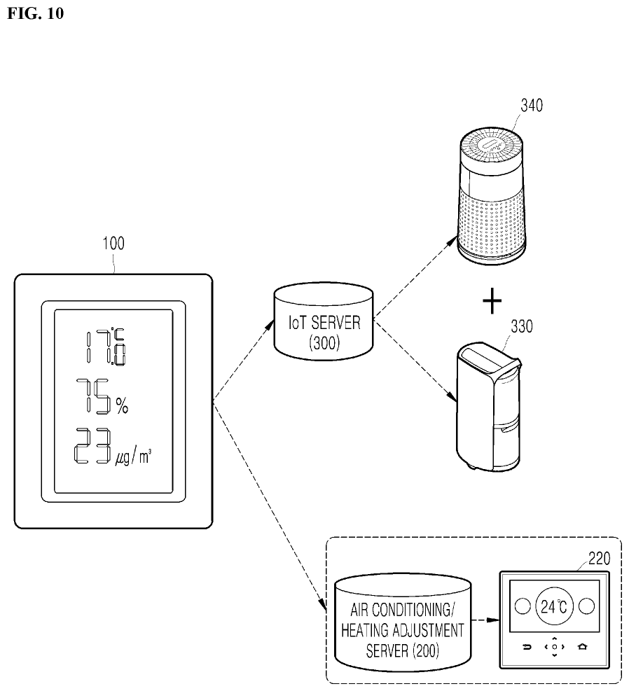

FIG. 10 is a diagram for describing a method for a thermo-hygrometer according to an embodiment of the present disclosure to control a home appliance and heating system when temperature is lower than a target range and humidity is higher than a target range.

If the temperature and humidity detected by the sensor are 17° C. and 75% when the set environment mode is the maternity mode, the thermo-hygrometer 100 may generate control signals for turning on the dehumidifier 330, the air purifier 340, and the heating system 220 and turning off the heating system 220, the air purifier 340, and the dehumidifier 330 after the temperature has sufficiently increased and the humidity has sufficiently decreased, and may transmit a signal for controlling the heating system 220 to the air conditioning/heating adjustment server 200 and a signal for controlling the dehumidifier 330 and the air purifier 340 to the Internet-of-things server 300 since the temperature is lower than the target temperature range of 21-23° C. according to the set environment mode and the humidity is higher than the target humidity range of 45-55%.

Here, unlike the example illustrated in FIG. 6, the air purifier 340 is also operated in addition to the dehumidifier 330 since the air purifier 340 is also capable of partially performing a function of a dehumidifier by suctioning and filtering air in addition to a function of improving air quality.

The Internet-of-things server 300 may operate the air purifier 340 and the dehumidifier 330 according to the received control signal, and the air conditioning/heating adjustment server 200 may operate the heating system 220 according to the received control signal so that the temperature and humidity may reach the target temperature range and humidity range.

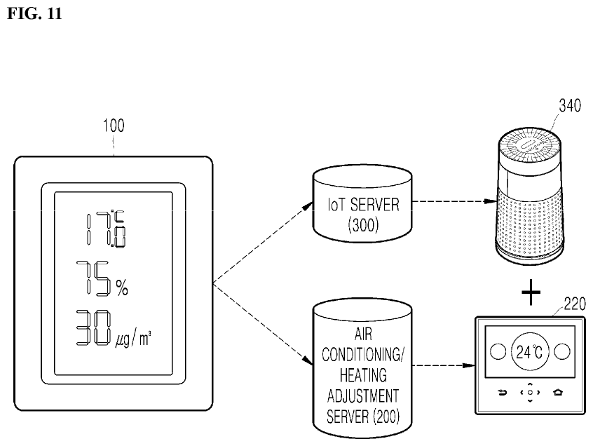

FIG. 11 is a diagram for describing another method for a thermo-hygrometer according to an embodiment of the present disclosure to control a home appliance and heating system when temperature is lower than a target range and humidity is higher than a target range.

FIG. 11 illustrates the case in which the dehumidifier 330 is not arranged in a home or office.

If the temperature and humidity detected by the sensor are 17° C. and 75% when the set environment mode is the maternity mode, the thermo-hygrometer 100 may generate control signals for turning on the air purifier 340 capable of performing a dehumidification function instead of the dehumidifier 330 and turning on the heating system 220, and turning off the air purifier 340 and the heating system 220 after the temperature has sufficiently increased and the humidity has sufficiently decreased, and may transmit a signal for controlling the heating system 220 to the air conditioning/heating adjustment server 200 and a signal for controlling the air purifier 340 to the Internet-of-things server 300 since the temperature is lower than the target temperature range of 21-23° C. according to the set environment mode and the humidity is higher than the target humidity range of 45-55%.

The Internet-of-things server 300 may operate the air purifier 340 according to the received control signal, and the air conditioning/heating adjustment server 200 may operate the heating system 220 according to the received control signal so that the temperature and humidity may reach the target temperature range and humidity range.

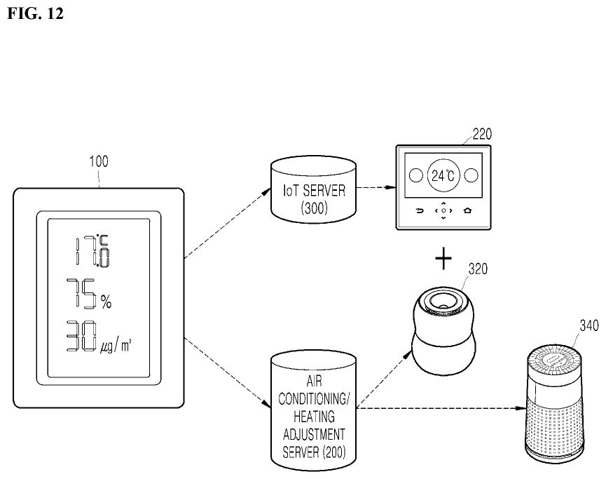

FIG. 12 is a diagram for describing another method for a thermo-hygrometer according to an embodiment of the present disclosure to control a home appliance and heating system when temperature and humidity are lower than target ranges.

If the temperature and humidity detected by the sensor are 17° C. and 15% when the set environment mode is the maternity mode, the thermo-hygrometer 100 may generate control signals for turning on the heating system 220, and turning off the air purifier 340 and turning on the humidifier 320 after the temperature has sufficiently increased, and turning off the heating system 200 and the humidifier 320 and turning on the air purifier 340 again after the humidity has sufficiently increased, and may transmit a signal for controlling the heating system 220 to the air conditioning/heating adjustment server 200 and a signal for controlling the humidifier 320 and the air purifier 340 to the Internet-of-things server 300 since the temperature is lower than the target temperature range of 21-23° C. according to the set environment mode and the humidity is lower than the target humidity range of 45-55%.

The Internet-of-things server 300 may operate the air purifier 340 according to the received control signal, and the air conditioning/heating adjustment server 200 may operate the heating system 220 according to the received control signal so that the temperature and humidity may reach the target temperature range and humidity range.

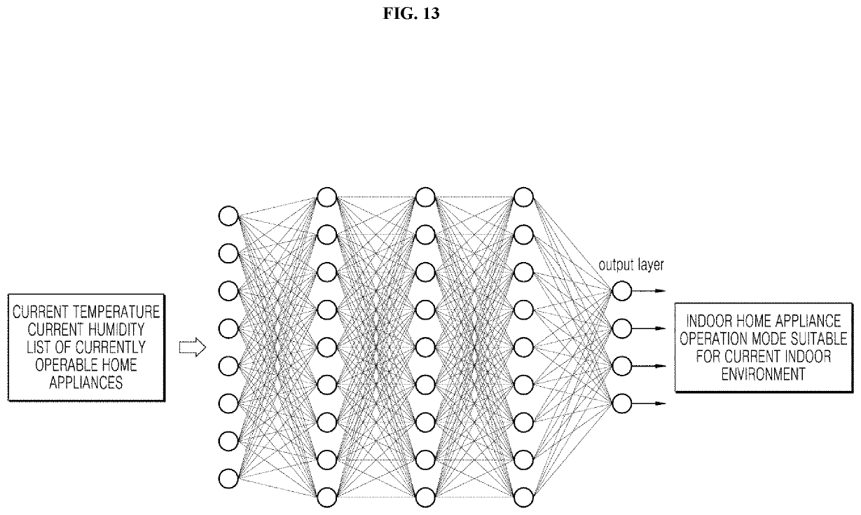

FIG. 13 is a diagram illustrating a deep neural network model for generating another scheme for a thermo-hygrometer according to an embodiment of the present disclosure to control a home appliance and air conditioning/heating system.

By using a technology of the field of artificial intelligence, a deep neural network model may be generated, which may determine an optimal combination of home appliances and air conditioning/heating systems required to be operated in order to change a temperature and humidity so that the temperature and humidity fall within a target temperature range and target humidity range set by the user.

This deep neural network model may be used to output an indoor home appliance suitable for current conditions and a suitable operation mode of an air conditioning/heating system when a current temperature, a current humidity, and a list of currently operable devices are input.

In order to train the deep neural network model, a large amount of data is required, which is obtained by observing changes in temperature and humidity while a corresponding home appliance and air conditioning/heating system are operated in a specific mode for a certain time at a specific temperature and humidity as described above. By using this data, a deep neural network model for predicting an optimal operation of a home appliance or air conditioning/heating system for achieving a specific temperature and humidity may be generated.

Artificial intelligence (AI) is a field of computer engineering and information technology that researches a method for the computer to enable thinking, learning, self-development, etc. which are possible by human's intelligence, and means that the computer can imitate human's intelligent behavior.

In addition, the Artificial Intelligence does not exist in itself, but has many direct and indirect links with other fields of computer science. In recent years, there have been numerous attempts to introduce an element of AI into various fields of information technology to solve problems in the respective fields.

Machine Learning is a field of Artificial Intelligence, and a field of research that gives the ability capable of learning without an explicit program in the computer.

Specifically, the Machine Learning can be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Many Machine Learning algorithms have been developed on how to classify data in the Machine Learning. Decision Tree, Bayesian network, Support Vector Machine (SVM), Artificial Neural Network (ANN), etc. are representative examples.

The Decision Tree is an analytical method that performs classification and prediction by plotting a Decision Rule in a tree structure.

The Bayesian network is a model of the probabilistic relationship (conditional independence) between multiple variables in a graphical structure. The Bayesian network is suitable for data mining through Unsupervised Learning.

The Support Vector Machine is a model of Supervised Learning for pattern recognition and data analysis, and mainly used for classification and regression.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that has artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the Artificial Neural Network can include the synapse for connecting between neuron and neuron.

The Artificial Neural Network can be generally defined by three factors, that is, (1) a connection pattern between neurons of different layers, (2) a learning process updating the weight of connection, (3) an activation function generating an output value from the weighted sum of the input received from a previous layer.

The Artificial Neural Network can include network models of the method such as Deep Neural Network (DNN), Recurrent Neural Network (RNN), Bidirectional Recurrent Deep Neural Network (BRDNN), Multilayer Perceptron (MLP), and Convolutional Neural Network (CNN), but is not limited thereto.

In the present specification, the term ‘layer’ can be used interchangeably with the term ‘class.’

An ANN may be classified as a single-layer neural network or a multi-layer neural network, based on the number of layers therein.

In general, a single-layer neural network may include an input layer and an output layer.

In addition, a general Multi-Layer Neural Network is composed of an Input layer, one or more Hidden layers, and an Output layer.

The Input layer is a layer that accepts external data, the number of neurons in the Input layer is equal to the number of input variables, and the Hidden layer is disposed between the Input layer and the Output layer and receives a signal from the Input layer to extract the characteristics to transfer it to the Output layer. The output layer receives a signal from the hidden layer and outputs an output value based on the received signal. The Input signal between neurons is multiplied by each connection strength (weight) and then summed, and if the sum is larger than the threshold of the neuron, the neuron is activated to output the output value obtained through the activation function.

Meanwhile, the Deep Neural Network including a plurality of Hidden layers between the Input layer and the Output layer can be a representative Artificial Neural Network that implements Deep Learning, which is a type of Machine Learning technology.

The Artificial Neural Network can be trained by using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

Meanwhile, the training data represents a plurality of features, and the labeling the label on the training data can mean that the feature represented by the training data is labeled. In this case, the training data can represent the feature of the input object in the form of a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

The Reinforcement Learning can be mainly performed by a Markov Decision Process (MDP).

Explaining the Markov Decision Process, firstly, the environment in which the agent has the necessary information to do the following actions is given, secondly, it is defined how the agent behaves in the environment, thirdly, i it is defined how to give reward or penalty to the agent, and fourthly, the best policy is obtained by repeatedly experiencing until the future reward reaches its peak.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

An operation of a home appliance required for achieving a specific temperature and humidity may be more accurately estimated using the above schemes.

In addition to the pieces of information illustrated in FIG. 13, a variety of information related to indoor environment conditions and conditions of home appliances and air conditioning/heating systems may be included in the input information, and, in this case, it would be obvious that a deep neural network model suitable for this case may be trained and used.

The thermo-hygrometer according to an embodiment of the present disclosure may continuously maintain a target indoor environment effectively by providing a method of controlling indoor home appliances through an optimal scheme for achieving the target indoor environment.

Furthermore, the thermo-hygrometer according to an embodiment of the present disclosure may maintain a target indoor environment while efficiently controlling conflicting home appliances by recognizing a relationship between home appliances having opposite effects on an indoor environment when operating indoors.

Furthermore, the thermo-hygrometer according to an embodiment of the present disclosure may efficiently control an indoor environment by restricting home appliances having opposite effects on an indoor environment when operating simultaneously from operating simultaneously.

Furthermore, the thermo-hygrometer according to an embodiment of the present disclosure may efficiently control home appliances arranged in each space so that different environment configurations may be automatically set for each indoor space.

Furthermore, the thermo-hygrometer according to an embodiment of the present disclosure may integrally control an environment using both an Internet-of-things server and an indoor heating control server.

The above-mentioned embodiments of the present disclosure may be implemented as a computer program executable in computer(s) through various constituent elements. The above-mentioned computer program may be recorded in a computer readable medium. The computer readable medium may include a non-transitory computer readable medium (e.g., a memory device). Examples of the computer readable medium may include magnetic media such as a hard disk drives (HDD), floppy disks and a magnetic tapes, optical media such as CD-ROMs and DVDs, magneto-optical media such as floptical disks, or hardware devices such as ROMs, RAMs, and flash memories specifically configured to store and execute program commands.

In addition, the above computer programs may be specially designed and configured for the present disclosure, or may be known to those skilled in the field of computer software. Examples of program code include both a machine code, such as produced by a compiler, and a higher-level code that may be executed by the computer using an interpreter.

In the present application (especially, in the appended claims), the use of the terms “the”, “the above-mentioned”, and/or other terms similar thereto may correspond to singular meaning, plural meaning, or both of the singular meaning and the plural meaning as necessary. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The above-mentioned steps constructing the method disclosed in the present disclosure may be performed in a proper order unless explicitly stated otherwise. However, the scope or spirit of the present disclosure is not limited thereto. All examples described herein or the terms indicative thereof (“for example”, etc.) used herein are merely to describe the present disclosure in greater detail. In addition, technical ideas of the present disclosure can also be readily implemented by those skilled in the art according to various conditions and factors within the scope of the appended claims to which various modifications, combinations, and changes are added, or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

What is claimed is:

1. A thermo-hygrometer comprising:
a sensor configured to detect at least one of a temperature or a humidity of an indoor space;
a non-transitory memory configured to store information about at least a portion of home appliances that are arranged in the indoor space;
a communicator configured to communicate information on an indoor environment of the indoor space or operation of at least the portion of the home appliances with an external device; and
a controller configured to generate a control signal for controlling at least the portion of the home appliances to adjust the indoor environment of the indoor space based on information about at least one of the temperature or the humidity detected by the sensor.

2. The thermo-hygrometer of claim 1, wherein the controller is further configured to:
generate a test signal for sequentially operating one or more of the home appliances;
receive, from the sensor, information about a change in the temperature or a change in the humidity based on operation of each of the one or more of the home appliances;
generate information about an influence of each of the one or more of the home appliances on the temperature or the humidity based on the information about the change in the temperature or the change in the humidity;
store, in the non-transitory memory, the information about the influence of each of the one or more of the home appliances on the temperature or the humidity; and
generate the control signal to restrict simultaneous operation of two or more of the home appliances having opposite influences on the temperature or the humidity.

3. The thermo-hygrometer of claim 1, wherein the communicator comprises a receiver configured to receive, from a user terminal, a signal for setting an environment mode for the indoor space,
wherein the environment mode comprises information about a target temperature range and a target humidity range, and
wherein the controller is further configured to:
generate the control signal based on the environment mode, the information about at least one of the temperature or the humidity detected by the sensor, and the information about at least the portion of the home appliances.

4. The thermo-hygrometer of claim 3, wherein the controller is further configured to:
based on the temperature and the humidity detected by the sensor being outside of the target temperature range and the target humidity range, respectively, generate the control signal for controlling at least one of an air conditioner, a humidifier, a dehumidifier, or an air purifier arranged in the indoor space to thereby adjust the temperature and the humidity of the indoor space to the target temperature range and target humidity range, respectively.

5. The thermo-hygrometer of claim 4, wherein the controller is further configured to:
based on generating a signal for operating the humidifier, generate a signal for stopping operation of the air purifier running at a first state; and
based on generating a signal for stopping the operation of the humidifier, generate a signal for restoring the operation of the air purifier to the first state.

6. The thermo-hygrometer of claim 3, wherein the controller is further configured to:
based on the temperature detected by the sensor being higher than the target temperature range and the humidity detected by the sensor being lower than the target humidity range, generate a control signal for:
operating an air conditioner arranged in the indoor space until the temperature detected by the sensor corresponds to the target temperature range,
stopping operation of an air purifier running at a first state in the indoor space, and operating a humidifier arranged in the indoor space until the humidity detected by the sensor corresponds to the target humidity range, and
after stopping the operation of the humidifier, restoring the operation of the air purifier to the first state.

7. The thermo-hygrometer of claim 3, wherein the communicator further comprises:
a transmitter configured to transmit the control signal to at least one of (i) a heating adjustment server configured to control an indoor heating system or (ii) an Internet-of-things server configured to control the home appliances arranged in the indoor space, and
wherein the controller is further configured to:
generate a signal for controlling the indoor heating system through the heating adjustment server; and
generate a signal for controlling the home appliances through the Internet-of-things server.

8. The thermo-hygrometer of claim 3, wherein the communicator is further configured to:
receive, from a robot cleaner configured to clean the indoor space based on moving in the indoor space, map information about the indoor space and location information of the home appliances arranged in the indoor space;
receive, from one or more of the home appliances, temperature or humidity information of one or more spaces of the indoor space, the one or more of the home appliances being configured to detect a temperature or a humidity of the one or more spaces of the indoor space; and
receive, from the user terminal, (i) a first environment mode comprising a first target temperature range and a first target humidity range corresponding to a first space of the indoor space and (ii) a second environment mode comprising a second target temperature range and second target humidity range corresponding to a second space of the indoor space, and
wherein the controller is further configured to:
based on the map information, the location information of the home appliances, the temperature or humidity information received from the one or more of the home appliances, and the information about the temperature or humidity detected by the sensor, generate the control signal for controlling at least a portion of the home appliances to adjust a first temperature and a first humidity of the first space to the first target temperature range and the first target humidity range, respectively, and to adjust a second temperature and a second humidity of the second space to the second target temperature range and the second target humidity range, respectively.

9. The thermo-hygrometer of claim 8, wherein the controller is further configured to:
generate map data to be displayed through an augmented reality device, the map data comprising temperature and humidity information corresponding to the one or more spaces of the indoor space defined in the map information, the location information of the home appliances, the temperature or humidity information received from the one or more of the home appliances, and the information about the temperature or the humidity detected by the sensor, and
wherein the communicator is further configured to transmit the map data to the augmented reality device.

10. A method for controlling a thermo-hygrometer configured to adjust an indoor environment, the method comprising:
receiving a list of at least a portion of home appliances that are arranged in an indoor space;
detecting a temperature and a humidity of the indoor space by a sensor; and
generating a control signal for controlling at least a portion of the home appliances to adjust the indoor environment based on information about the temperature and the humidity detected by the sensor.

11. The method of claim 10, further comprising:
before generating the control signal, generating a test signal for sequentially operating one or more of the home appliances;
receiving, from the sensor, information about a change in the temperature or a change in the humidity based on operation of each of the one or more of the home appliances;
generating a deep neural network model for estimating operations of the home appliances required for changing the temperature or the humidity based on the information about the change in the temperature or the change in the humidity; and
storing the deep neural network model in a non-transitory memory of the thermo-hygrometer,
wherein generating the control signal comprises generating a control signal for each of the home appliances using the deep neural network model.

12. The method of claim 10, further comprising:
before generating the control signal, receiving an environment mode set for the indoor space, the environment mode comprising a target temperature range and a target humidity range,
wherein generating the control signal comprises:
generating a control signal for controlling at least a portion of the home appliances based on the environment mode, the temperature and the humidity detected by the sensor, and the list of at least the portion of the home appliances to thereby adjust the temperature and the humidity of the indoor space to the target temperature range and the target humidity range, respectively.

13. The method of claim 12, wherein generating the control signal comprises:
based on the temperature and the humidity detected by the sensor being outside of the target temperature range and the target humidity range, respectively, generating a control signal for controlling at least one of an air conditioner, a humidifier, a dehumidifier, or an air purifier arranged in the indoor space to thereby adjust the temperature and the humidity of the indoor space to the target temperature range and the target humidity range, respectively.

14. The method of claim 13, wherein generating the control signal comprises:
determining whether a signal for operating the humidifier is generated; and
based on a determination that the signal for operating the humidifier is generated, storing an operation state of the air purifier and generating a signal for stopping operation of the air purifier.

15. The method of claim 14, wherein generating the control signal comprises:
determining whether a signal for stopping operation of the humidifier is generated; and
based on a determination that the signal for stopping the operation of the humidifier is generated, generating a signal for resuming the operation state of the air purifier.

16. The method of claim 13, wherein generating the control signal comprises generating the control signal based on the temperature detected by the sensor being higher than the target temperature range and the humidity detected by the sensor being lower than the target humidity range, the control signal comprising:
a control signal for operating the air conditioner until the temperature detected by the sensor corresponds to the target temperature range;
a control signal for stopping operation of the air purifier running at a first state and operating the humidifier until the humidity detected by the sensor corresponds to the target humidity range; and
a control signal for restoring, after stopping operation of the humidifier, the operation of the air purifier to the first state.

17. The method of claim 10, further comprising:
before generating the control signal:
receiving, from a robot cleaner configured to clean the indoor space based on moving in the indoor space, map information about the indoor space and location information of the home appliances arranged in the indoor space;
receiving, from one or more of the home appliances, temperature or humidity information of one or more spaces of the indoor space, the one or more of the home appliances being configured to detect a temperature or a humidity of the one or more spaces of the indoor space; and
receiving, from a user terminal, a first environment mode corresponding to a first space of the indoor space and a second environment mode corresponding to a second space of the indoor space.

18. The method of claim 17, wherein the first environment mode comprises a first target temperature range and a first target humidity range corresponding to the first space,
wherein the second environment mode comprises a second target temperature range and a second target humidity range corresponding to the second space, and
wherein generating the control signal comprises:
based on the map information, the location information of the home appliances, the temperature or humidity information received from the one or more of the home appliances, and the information about the temperature or the humidity detected by the sensor, generating the control signal for controlling at least a portion of the home appliances to adjust a first temperature and a first humidity of the first space to the first target temperature range and the first target humidity range, respectively, and to adjust a second temperature and a second humidity of the second space to the second target temperature range and the second target humidity range, respectively.

19. The method of claim 18, further comprising:
after generating the control signal, generating map data to be displayed through an augmented reality device, the map data comprising temperature and humidity information corresponding to the one or more spaces of the indoor space defined by the map information, the location information of the home appliances, the temperature or humidity information received from the one or more of the home appliances, and the information about the temperature or the humidity detected by the sensor; and
transmitting the map data to the augmented reality device.

20. A non-transitory computer-readable recording medium having stored thereon a computer program which, when executed by at least one processor, causes performance of the method of claim 10.
